(19) United States
(12) Patent Application Publication
(10) Pub. No.: US 2007/0288596 A1
(43) Pub. Date: Dec. 13, 2007

(54) METHODS AND SYSTEMS FOR STORING CONTENT DEFINITION WITHIN A MEDIA FILE

(76) Inventor: Christopher Sindoni, San Francisco, CA (US)

Correspondence Address: PERKINS COIE LLP, P.O. BOX 2168, MENLO PARK, CA, 94026, US

(21) Appl. No.: 11/762,023

(22) Filed: Jun. 12, 2007

Related U.S. Application Data
(63) Continuation-in-part of application No. 11/784,391, filed on Apr. 5, 2007.
Application No. 11/784,391 is a continuation-in-part of application No. 11/669,111, filed on Jan. 30, 2007.
(60) Provisional application No. 60/765,228, filed on Feb. 3, 2006.

(51) Int. Cl. G06F 15/16

(52) U.S. Cl. 709/217

(57) ABSTRACT

Various embodiments of the present invention enable better utilization of a media file of a digital content by storing a definition of the digital content within a metadata section of the media file. A user may purchase, obtain, or download the media file of the content to a computing/communication device, interpret the content and generate a derivative version of the content based on the content definition, store and play the derivative version of the content on this or other computing/communication devices without the need of purchasing or obtaining the derivative version of the content again via other means.

### CLAIM OF PRIORITY

This application is a continuation-in part of Sindoni's co-pending U.S. Utility patent application Ser. Nos. 11/784,391, filed Apr. 5, 2007, and 11/669,111, filed Jan. 30, 2007, entitled “METHODS AND SYSTEMS FOR RINGTONE SHARING,” and U.S. Provisional Patent Application No. 60/765,228, filed Feb. 3, 2006, entitled “METHODS AND SYSTEMS FOR RINGTONE SHARING” by Christopher Sindoni, the contents of which are incorporated herein by reference.

### FIELD OF THE INVENTION

The present invention relates generally to content generation, and more specifically, to generating content from content definitions stored in a media file.

### BACKGROUND

With the popularity of broadband internet and wireless communications, digital contents are increasingly available online and shared among users via various computing and communication devices over a network. Here, the digital contents to be shared include but are not limited to, text files, images, audio/video clips, songs, ringtones, and any other multimedia content distributable in digital format. The computing and communication devices can be any of PDAs, cellular phones, desktop/laptop computers, and other mobile/handheld/wireless devices.

A digital content can be stored, downloaded, and shared in the form of a media file. The format of the media file typically follows a standard specification, where such format often includes a metadata section at the beginning, end, or other part of the media file. The metadata section allows information such as the title, artist, album, track number, or other information about the digital content to be stored in the media file itself. Increasingly, the latest specification of the metadata allows for much richer information and at least a portion of the metadata to be user defined. Accordingly, a need exists to better utilize and define the metadata section of the media file for content generation and sharing purposes.

### SUMMARY

Various embodiments of the present invention enable better utilization of a media file of a digital content by storing a definition of the digital content within a metadata section of the media file. A user may purchase, obtain, or download the media file of the content to a computing/communication device, interpret the content and generate a derivative version of the content based on the content definition, store and play the derivative version of the content on this or other computing/communication devices without the need of purchasing or obtaining the derivative version of the content again via other means.

### BRIEF DESCRIPTION OF THE DRAWINGS

The teachings of the present invention can be readily understood by considering the following detailed description in conjunction with the accompanying figures. However, the embodiments and figures are illustrative rather than limiting; they provide examples of the invention.

FIG. 1 is a block diagram illustrating an exemplary system to support creating a derivative version of a digital content based on a definition of the content stored within a media file of the content according to one embodiment of the present invention.

FIG. 2 is a flow chart illustrating an exemplary process to support creating a derivative version of a digital content based on a definition of the content stored within a media file of the content according to one embodiment of the present invention.

FIG. 3 shows an exemplary MP3 file format that can be utilized according to one embodiment of the present invention.

### DETAILED DESCRIPTION

In the following description, several specific details are presented to provide a thorough understanding of embodiments of the invention. One skilled in the relevant art will recognize, however, that the invention can be practiced without one or more of the specific details, or in combination with other components, etc. In other instances, well-known implementations or operations are not shown or described in detail to avoid obscuring aspects of various embodiments of the invention.

Various embodiments of the present invention enable better utilization of a media file of a digital content by storing a definition of the digital content within a metadata section of the media file. A user may purchase, obtain, or download the media file of the content to a computing/communication device, interpret the content and generate a derivative version of the content based on the content definition, store and play the derivative version of the content on this or other computing/communication devices without the need of purchasing or obtaining the derivative version of the content again via other means. Alternatively, the user may skip the storing step by simply generating and playing the derived version simultaneously on the fly if the playback device has enough processing power to process the content quickly enough.

In some embodiments, the digital content can be contained in one or more media files formatted in, for non-limiting examples, MPEG, GIF, JPEG, WAV, MP3, MIDI, WMA, MP4, AAC, AIFF, and other audio/video/multimedia formats. A definition of the digital content refers to a description (or characteristics) of the digital content and derivations, recipes, manipulations or edits that can be used to interpret the content and generate a derivative version of the content. The content description can include, but is not limited to, a title, a name, a unique identification number, a track number, a file format, a bit rate, a length, and other characteristics of the content. The manipulations (or edits) can include, but are not limited to, splices, ramping up, ramping down, blends, and mixes of the content or its components. Here, the content and its components refer to original source of text, image, video, audio (e.g., a full length MP3) and other multimedia files that can be copyrighted and licensed. The derivative version of content is the result of manipulations (or edits) to the one or more components of the content. The derivative version can be loaded onto a content receiver, such as a mobile telephone, in order to be enjoyed by its user.

For a non-limiting example, a section of an MP3 file of an audio clip (e.g., a piece of music) may be utilized to store a definition/recipe of the audio clip that can be used to interpret the audio clip and derive a ringtone version of the music. Consequently, a user can obtain/purchase/download and store the MP3 file of the audio clip to an electronic device, such as an iPhone, generate a ringtone of the audio clip directly from the MP3 file based on the definition/recipe stored in the file, and then store the new ringtone locally on the iPhone, where the ringtone will be played in response to a triggering event, such as an incoming call to the iPhone. Although an audio clip in MP3 format is used here for illustration purposes, the same idea can be applied to video and any other digital content in any suitable content formats.

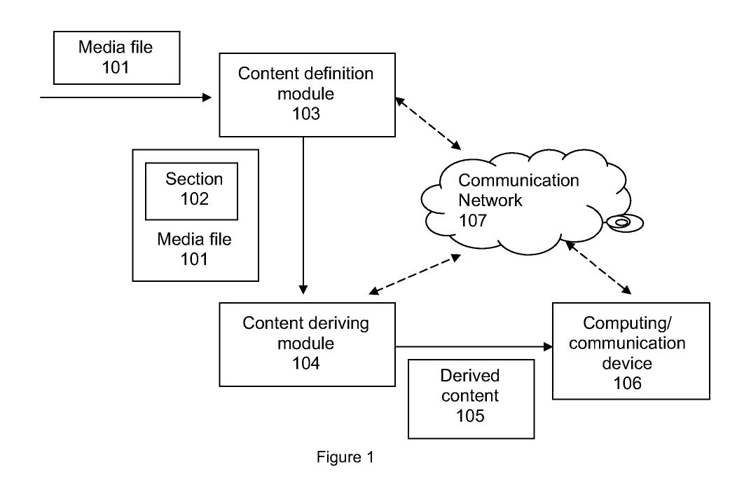

FIG. 1 is a block diagram illustrating an exemplary system 100 to support creating a derivative version of a digital content based on a definition of the content stored within a media file of the content according to one embodiment of the present invention. Although this diagram depicts components as functionally separate, such depiction is merely for illustrative purposes. It will be apparent to those skilled in the art that the components portrayed in this figure can be arbitrarily combined or divided into separate software, firmware and/or hardware components. Furthermore, it will also be apparent to those skilled in the art that such components, regardless of how they are combined or divided, can execute on the same computing device or multiple computing devices, and wherein the multiple computing devices can be connected by any variety of couplings such as a computer data bus and/or one or more networks.

Referring to FIG. 1, a content definition module 103 is operable to accept a media file 101 containing a digital content, and enable a user/application developer to define and/or store a definition of the digital content in a metadata section 102 of the media file, wherein section 102 can be the header of the media file. A content deriving module 104 is operable to accept the media file having the content definition section 102 via purchasing, licensing, and/or downloading, rip the content definition section 102 from the media file, and generate a derivative version 105 of the content by applying the ripped content definition to the original content. The derived content 105 can then be stored, accessed and played on a computing/communication device 106. Here, the computing/communication device can be one of a personal computer, a mobile telephone, a PDA, or other computing device. The content definition module and/or the content deriving module are software modules that can either run on the computing/communication device 106 or on separate computing/communication devices, which can communicate with device 106 via a communication network 107. Here, the communication network 107 can be one of internet, a local area network (LAN), a wide area network (WAN), a wired communication network, a short messaging system (SMS), a multimedia messaging system (MMS), a wireless application protocol (WAP), a telephone network, a data network, and other suitable network.

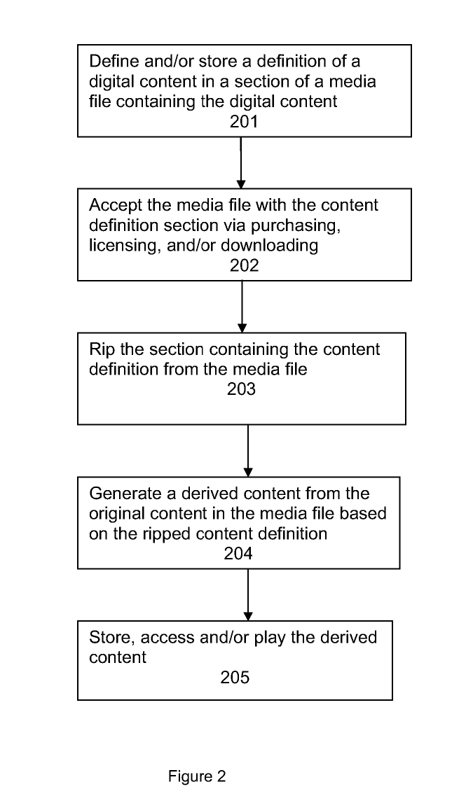

FIG. 2 is a flow chart illustrating an exemplary process to support creating a derivative version of a digital content based on a definition of the content stored within a media file of the content according to one embodiment of the present invention. Although this figure depicts functional steps in a particular order for purposes of illustration, the process is not limited to any particular order or arrangement of steps. One skilled in the art will appreciate that the various steps portrayed in this figure could be omitted, rearranged, combined and/or adapted in various ways.

Referring to FIG. 2, a definition of a digital content is defined and/or stored in a section of a media file containing the digital content at step 201. At step 202, the media file with the content definition section is accepted via purchasing, licensing, and/or downloading. At step 203, the section containing the content definition is ripped from the media file. At step 204, a derived content is generated from the original content in the media file based on the ripped content definition, and the derived content can be optionally stored, accessed and/or played at step 205.

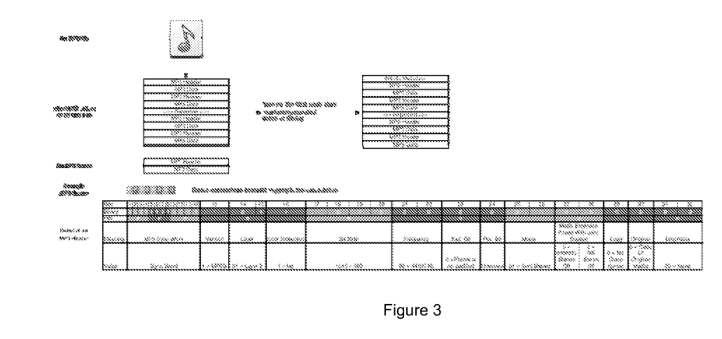

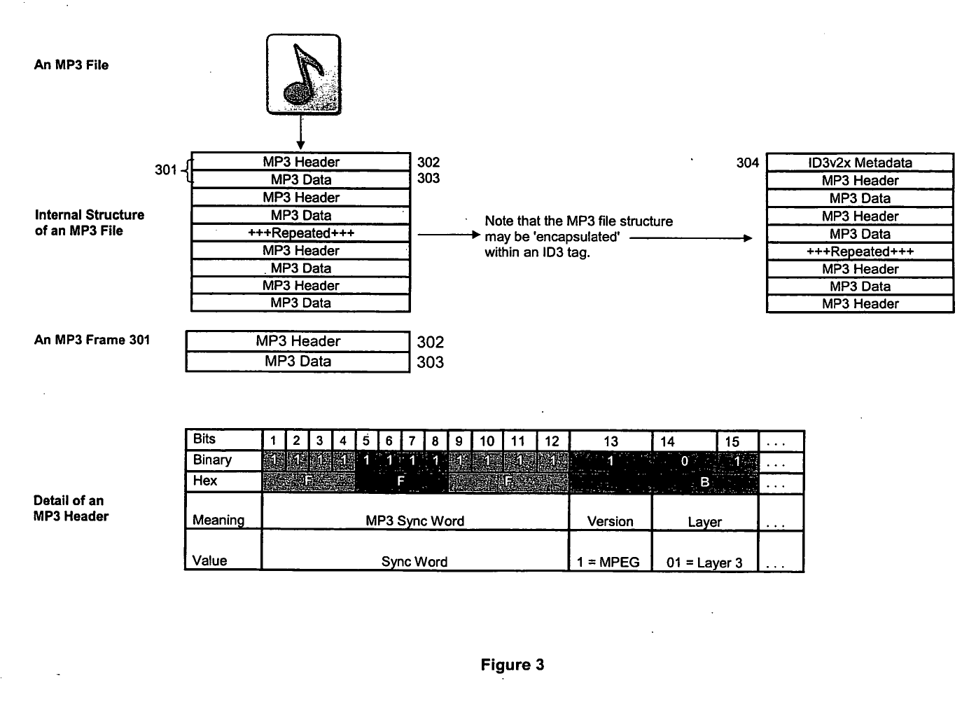

In some embodiments, the media file can be an MP3 file, which is made up of multiple MP3 frames 301 consisting of an MP3 header 302 and MP3 data 303 as shown in FIG. 3. Each frame 301 is an independent item: one can cut an MP3 file into multiple frames and an MP3 player would be able to play it and the MP3 data is the actual audio payload. The MP3 header 302 consists of a sync word which is used to identify the beginning of a valid frame, followed by a bit indicating that this is the MPEG standard and two bits that indicate that layer 3 is being used, hence MPEG-1 Audio Layer 3 or MP3. The range of values for each section of the header along with the specification of the header can be defined according to ISO/IEC 11172-3.

Most MP3 files today contain an ID3 metadata section 304, which precedes or follows the MP3 frames. Metadata can generally be used to facilitate the understanding, use and management of content, which in the case of MP3 is the audio clip. ID3 is a metadata most often used in conjunction with the MP3 audio file format. It allows information such as the title, artist, album, track number, or other information about the file to be stored in the file itself. ID3 can be of variable size, and usually occur at the start of the MP3 file to aid streaming media. The ID3 itself may consist of a number of frames, each of which contains a piece of metadata and can be 16 MB in length. In the latest ID3v2 standard there are 84 types of frames, including standard frames for containing album cover art, copyright and license, lyrics, and arbitrary text and URL data, as well as other things. For non-limiting examples, the TIT2 frame contains the title, and the WOAR frame contains the URL of the artist's website. Most importantly, the ID3 metadata can be user defined, i.e., users can also define their own types/content of frame, such as the definition (manipulation) of the audio clip.

In some embodiments, the content definition stored in the media file comprises characteristics of and edits that can be made to the original digital content in order to generate the corresponding derivative version of the content. For a non-limiting example, a media application developer may define the rules/operations needed to convert an MP3 audio clip to a ringtone version of the same piece of music and store such content definition in one or more frames of ID3 in the MP3 file.

The non-limiting example of MP3 audio format discussed above is illustrative and not limiting. One ordinarily skilled in the art will understand that a system suitable to carry out the methods of the invention may include any additional audio/video media formats. An exhaustive list of all combinations and permutations of embodiments has not been attempted here but one skilled in the relevant art will recognize alternative embodiments based on the system described above.

In some embodiments, the content definition can be purchased from a content designer/originator, which can be a separate source from the source of the media file. The content definition can subsequently be downloaded by a content receiver/user who subscribes to the provider's services. The content definition module is operable to put the separate content definition and the media file it refers to together by storing the content definition in the metadata section of the media file.

In some embodiments, the user or application developer may send a query for a specific content definition identified by characteristics such as title, artist name, name, track number, and the type of media to be derived. The content definition module receives the query, search a local or remote database for the definition, and identify the content definition matching the query. In one embodiment, the content definition module conducts the search using tolerance metrics to account for content component(s) that are substantially similar despite variances in format, bit rate, song length, and the like. If such content definition cannot be located, the content definition module enables the user/application developer (DJ) to create the content definition and associate the self-created content definition with the target media file.

In some embodiments, the content definition module may enable the user/application developer to create his/her own definition of the digital content via audio-editing software through a user interface such as a computer monitor. In one embodiment, a user may create the content definition by performing manipulations of the content, wherein the manipulations may include, but are not limited to, splices, ramp ups, ramp downs, blending, start frame, stop frame, fades, special effects, and the like. The content definition module records the user's interactions/manipulations of the content, create the corresponding content definition and store the definition in the metadata section of the media file. These stored manipulations can later be ripped from the media file by the content deriving module in order to generate a derived version of the content as the user desired.

In some embodiments, the content deriving module is operable to generate the derivative version of the content based on the characteristics of the content definition by editing the original content according to the manipulations set in the content definition. The content deriving module may then send the derived content (e.g., ringtone) to a computing/communication device, which for a non-limiting example, can be a mobile telephone, which stores the derived content in a local database or memory (not shown). The device may include a playback module (e.g., a Windows® Media Player or a RealAudio® media player) to play the derived content.

In some embodiments, the computing/communication device may play the derivative version of the content while such content is being derived by the same device without accepting and storing such derived content in its entirety first. This may happen under the condition that the device has enough computing/ processing power and memory to play the derived content while it is being generated on the fly.

The scenarios discussed above are exemplary and it is understood by one skilled in the art that one or more content definitions may be created, located, and subsequently shared over a communication network. An exhaustive list of all combinations and permutations of embodiments has not been attempted here but one skilled in the relevant art will recognize alternative embodiments based on the system described above.

The order in which the steps of the methods of the present invention are performed is purely illustrative in nature. The steps can be performed in any order or in parallel, unless otherwise indicated by the present disclosure. The methods of the present invention may be performed in hardware, firmware, software, or any combination thereof operating on a single computer or multiple computers of any type. Software embodying the present invention may comprise computer instructions in any form (e.g., source code, object code, interpreted code, etc.) stored in any computer-readable storage medium (e.g., a ROM, a RAM, a magnetic media, a compact disc, a DVD, etc.). Such software may also be in the form of an electrical data signal embodied in a carrier wave propagating on a conductive medium or in the form of light pulses that propagate through an optical fiber.

While particular embodiments of the present invention have been shown and described, it will be apparent to those skilled in the art that changes and modifications may be made without departing from this invention in its broader aspect and, therefore, the appended claims are to encompass within their scope all such changes and modifications, as fall within the true spirit of this invention. For a non-limiting example, the systems and methods of the present invention can be used to share definitions of any type of multimedia file, such as video. Additionally, content can be generated for a variety of uses such as ringbacks (i.e., content played to a caller on an outgoing call while waiting for a called party to answer), and other edited content.

In the above description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” or “some embodiments” means that a particular feature, structure, or characteristic described in connection with the embodiment(s) is included in at least one embodiment of the invention. The appearances of the phrase “in one embodiment” in various places in the specification are not necessarily all referring to the same embodiment.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus can be specially constructed for the required purposes, or it can comprise a general-purpose computer selectively activated or reconfigured by a computer program stored in the computer. Such a computer program can be stored in a computer readable storage medium, such as, but is not limited to, any type of disk including floppy disks, optical disks, CD-ROMs, and magnetic-optical disks, read-only memories (ROMs), random access memories (RAMS), EPROMs, EEPROMs, magnetic or optical cards, or any type of media suitable for storing electronic instructions, and each coupled to a computer system bus.

The algorithms and modules presented herein are not inherently related to any particular computer or other apparatus. Various general-purpose systems can be used with programs in accordance with the teachings herein, or it may prove convenient to construct more specialized apparatuses to perform the method steps. The required structure for a variety of these systems will appear from the description herein. In addition, the present invention is not described with reference to any particular programming language. It will be appreciated that a variety of programming languages can be used to implement the teachings of the invention as described herein. Furthermore, as will be apparent to one of ordinary skill in the relevant art, the modules, features, attributes, methodologies, and other aspects of the invention can be implemented as software, hardware, firmware or any combination of the three. Of course, wherever a component of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of skill in the art of computer programming. Additionally, the present invention is in no way limited to implementation in any specific operating system or environment.

It will be understood by those skilled in the relevant art that the above-described implementations are merely exemplary, and many changes can be made without departing from the true spirit and scope of the present invention. Therefore, it is intended by the appended claims to cover all such changes and modifications that come within the true spirit and scope of this invention.

What is claimed is:

1. A system to support storing content definition within a media, comprising:
a content definition module operable to:
accept a media file containing a digital content; and
enable a user to define and/or store a definition of the digital content in a section of the media file;
a content deriving module operable to:
accept the media file with the section of the definition of the digital content;
rip the section of the definition from the media file; and
generate a derivative version of the digital content by applying the definition to the digital content.

2. A system to support storing content definition within a media, comprising:
a media file containing a digital content;
a definition of the digital content;
a content definition module operable to store the definition within a section of the within the media file; and
a content deriving module operable to apply the stored definition to generate a derivative version of the digital content.

3. The system of claim 1, further comprising:
a computing or communication device operable to store, access or play the derivative version of the digital content.

4. The system of claim 3, wherein:
the computing or communication device is one or more of a personal computer, a mobile telephone, a PDA, and any other mobile/handheld/wireless device.

5. The system of claim 3, wherein:
the content defining module and/or the content deriving module run on the computing or communication device, or communicate with the computing or communication device via a communication network.

6. The system of claim 5, wherein:
the communication network includes at least one of Internet, a local area network (LAN), a wide area network (WAN), a wired communication network, a short messaging system (SMS), a multimedia messaging system (MMS), a wireless application protocol (WAP), a telephone network, and a data network.

7. The system of claim 3, wherein:
the computing or communication device further comprises a playback module.

8. The system of claim 3, wherein:
the computing or communication device is further operable to play the derivative version of the digital content while the content is being derived.

9. The system of claim 3, wherein:
the computing or communication device is further operable to play the derivative version of the digital content while there is a triggering event.

10. The system of claim 9, wherein:
the triggering event is an incoming call.

11. The system of claim 1, wherein:
the digital content is one or more of: a text file, an image, an audio/video clip, a song, a ringtone, and any other multimedia content distributable in digital format.

12. The system of claim 1, wherein:
the definition of the digital content includes one or more of: a description of characteristics of the digital content, a derivation, a recipe, and one or more manipulations or edits that can be used to interpret and generate the derivative version of the content.

13. The system of claim 12, wherein:
the content description includes one or more of a title, a name, a unique identification number, a track number, a file format, a bit rate, a length, and other characteristics of the content.

14. The system of claim 12, wherein:
the one or more manipulations include splices, ramp ups, ramp downs, blending, start frame, stop frame, fades, and special effects.

15. The system of claim 1, wherein:
the media file is purchased, licensed, or downloaded.

16. The system of claim 1, wherein:
the media file is in the format of one of: MPEG, GIF, JPEG, WAV, MP3, MIDI, WMA, MP4, AAC, AIFF, or other audio/video/multimedia format.

17. The system of claim 1, wherein:
the section in the media file contains metadata.

18. The system of claim 17, wherein:
the metadata comprises a plurality of frames covering copyright, license, lyrics, arbitrary text and URL data.

19. The system of claim 17, wherein:
a portion of the metadata is user-defined.

20. The system of claim 1, wherein:
the content definition module is further operable to:
accept a query for a specific definition of the content;
search a local or remote database for the definition; and
identify the content definition matching the query.

21. The system of claim 1, wherein:
the content definition module is further operable to:
enable the user to create the definition of the digital content via an audio-editing software; and
record the user's interactions and/or manipulations of the digital content.

22. A method to support storing content definition within a media, comprising:
defining and/or storing a definition of a digital content in a section of a media file containing the digital content;
accepting the media file with the section containing the definition of the content;
ripping the section containing the definition from the media file; and
generating a derivative version of the digital content by applying the definition to the digital content.

23. A method to support storing content definition within a media, comprising:
storing a definition of a digital content within a section of a media file containing the digital content; and
applying the stored definition to generate a derivative version of the digital content.

24. The method of claim 22, further comprising:
storing, accessing or playing the derivative version of the digital content.

25. The method of claim 22, further comprising:
playing the derivative version of the digital content while the content is being derived.

26. The method of claim 22, further comprising:
playing the derivative version of the digital content while there is a triggering event.

27. The method of claim 22, further comprising:
purchasing, licensing, or downloading the media file.

28. The method of claim 22, further comprising:
accepting a query for a specific definition of the content;
searching a local or remote database for the definition; and
identifying the content definition matching the query.

29. The method of claim 22, further comprising:
enabling the user to create the definition of the digital content via an audio-editing software; and
recording the user's interactions and/or manipulations of the digital content.

30. A machine readable medium having instructions stored thereon that when executed cause a system to:
define and/or store a definition of a digital content in a section of a media file containing the digital content;
accept the media file with the section containing the definition of the content;
rip the section containing the definition from the media file; and
generate a derivative version of the digital content by applying the definition to the digital content.

31. A system to support storing content definition within a media, comprising:
means for storing a definition of a digital content within a section of a media file containing the digital content; and
means for applying the stored definition to generate a derivative version of the digital content.
